(19) United States
(12) Patent Application Publication
(10) Pub. No.: US 2010/0323324 A1
(43) Pub. Date: Dec. 23, 2010

(54) Blocking Having Joining Structure of Dental Implant Abutment and Upper Structure and Manufacturing Method of the Same

(76) Inventor: Dae Hyun Kim, Seoul (KR)

Correspondence Address: LEXYOUME IP GROUP, PLLC, 5180 PARKSTONE DRIVE, SUITE 175, CHANTILLY, VA, 20151, US

(21) Appl. No.: 12/518,015

(22) PCT Filed: Dec. 7, 2007
(86) PCT No.: PCT/KR2007/006365

§ 371 Date: Jun. 5, 2009

(30) Foreign Application Priority Data
Dec. 7, 2006 (KR) 10-2006-0124051

(51) Int. Cl. A61C 8/00

(52) U.S. Cl. 433/173; 433/201.1

(57) ABSTRACT

Disclosed are a block having a structure for joining an abutment and a superstructure for a dental implant and a method for manufacturing the same. An abutment and a superstructure are not shaped in advance, and instead, a block, in which a structure for joining a fixture and other connection parts of a dental prosthesis are formed, is manufactured such that the block can be machined through CAD/CAM, or, after a wax mock-up or a resin mock-up is scanned and drawn on a paper, the block can be machined through CAM to form an abutment or the crown of a superstructure. In order to provide high strength and high toughness, the block is made of a stabilized tetragonal zirconia polycrystalline (TZP)-based material or a composite of zirconia and oxide. The method comprises the steps of pressing a starting material for a block, machining a resultant formation, and sintering the machined formation.

### TECHNICAL FIELD

The present invention relates to a block having a structure for joining an abutment and a superstructure for a dental implant and a method for manufacturing the same, wherein, when manufacturing an abutment and a superstructure for a dental implant, the abutment and the superstructure are not shaped in advance, and instead, a block, in which a structure for joining a fixture and other connection parts of a dental prosthesis are formed, is manufactured such that the block can be machined through CAD/CAM, or, after a wax mock-up or a resin mock-up is scanned and drawn on paper, the block can be machined through CAM to form an abutment or the crown of a superstructure, and wherein, in order to provide high strength and high toughness, the block is made of a stabilized tetragonal zirconia polycrystalline (TZP)-based material or a composite of zirconia and oxide. To this end, the method for manufacturing a block having a structure for joining an abutment and a superstructure for a dental implant according to the present invention comprises the steps of pressing a starting material for a block, machining a resultant formation, and sintering the machined formation.

### BACKGROUND ART

As is well known in the art, a dental implant indicates an artificial tooth structure which is formed by anchoring a fixture serving as an artificial dental root to alveolar bone through the gums at a position at which a tooth has been partially or wholly lost, and then securing a dental prosthesis to the artificial root. The term ‘implant’ can be used in a broad sense as a comprehensive concept that includes a method of performing dental surgery and in a narrow sense as meaning the fixture. In the present specification, the term “implant” can generally be understood to indicate an artificial tooth structure.

In general, the implant is composed of a fixture, which is made of titanium, an abutment, which is secured to the fixture, an abutment screw, which secures the abutment to the fixture, and a crown, which is fastened to the abutment and defines the outermost upper portion of the artificial tooth.

The implant can be inserted only at a place where a tooth has been lost without damaging the neighboring teeth or tissues, can support bone tissues to thus retard the resorption speed of the bone tissue, can support mastication force of the same magnitude as a natural tooth, and can render substantially the same outer appearance as the natural tooth.

After a predefined period elapses after a dental implant is inserted into a jaw bone, a dental prosthesis is connected to the implant, which is positioned in the jaw bone. At this time, an abutment is needed to support the upper portion of the dental prosthesis. To date, metal, such as titanium and gold alloy, and ceramic, such as Al₂O₃ and ZrO₂ have been used as the material of the abutment.

However, if metal is used as the material of the abutment, when the thickness or the amount of surrounding soft tissues is small, disadvantages are caused in that the color of the metal is likely to be visible, or the surrounding tissues are perceived as gray, whereby a serious defect can result in the front teeth of the upper jaw, which play an important role from an aesthetical point of view.

While ceramic is also used as the material of the abutment in view of the excellent properties thereof so as to satisfy the aesthetic demands of some patients, problems arise in terms of working efficiency and the color of the teeth. In particular, while, in actuality, ceramic products are made by only a few specialized bio ceramic companies having technical expertise, even in this case, a problem is caused in that the level of ceramic technology is insufficient, and thus they cannot be properly used in the art. Therefore, in spite of the excellent properties of ceramic, it cannot be properly used as the material for the abutment due to the unsatisfactory state of ceramics technology and the inconvenience imposed on a patient.

When installing an implant, it is very important that a dental prosthesis conform to the shape of a patient's tooth and that the dental prosthesis be precisely placed. To this end, a precise dental model must be made by taking the mold of a patient's tooth using an impression material, and a precise dental prosthesis must be prepared using the mold, and must be installed in place. Since the ready-made abutments as a whole have uniform shapes and should be re-shaped, or the shape thereof should be corrected to conform with the shapes of respective patients' teeth, the time required to manufacture dental prostheses is lengthened, and it is troublesome to implement the processes for manufacturing dental implants.

### DISCLOSURE OF INVENTION

### Technical Problem

Accordingly, the present invention has been made in an effort to solve the problems occurring in the related art, and an object of the present invention is to provide a block having a structure for joining an abutment and a superstructure for a dental implant and a method for manufacturing the same, wherein, when an artificial tooth for a dental implant is formed of ceramic or polymer, a block can be immediately machined to conform to an individual patient without causing any inconvenience attributable to the necessity to reshape a ready-made abutment having a uniform shape, so that an implantation process can be quickly, conveniently and precisely conducted for each patient.

Another object of the present invention is to provide a block having a structure for joining an abutment and a superstructure for a dental implant and a method for manufacturing the same, wherein a block having a rotation-preventing connection part formed on an end thereof to prevent a fixture from rotating is manufactured in advance, and the artificial tooth portion of the block, including the connection part, is machined as the occasion demands, so that shaping according to the measurements of a patient can be more easily conducted compared to the conventional art, in which a wax mock-up or a resin mock-up process is separately conducted for a ready-made product having a uniform shape so as to define a complete shape conforming to an individual patient.

Still another object of the present invention is to provide a block having a structure for joining an abutment and a superstructure for a dental implant and a method for manufacturing the same, wherein an abutment and a superstructure for a dental implant are formed of a ceramic material, having high strength and high toughness, or a resin-based material, which is easy to machine and is advantageous in terms of cost.

### Technical Solution

In order to achieve the above object, according to one aspect of the present invention, there is provided a dental implant in which a fixture is inserted through a portion of a gum at which a tooth has been lost, and is anchored to an alveolar bone, which is an artificial dental root, and a dental prosthesis is secured to the fixture to form an artificial tooth, wherein a block is formed through machining to serve as an abutment, an upper artificial tooth structure or an integration of an abutment and an artificial tooth structure, and has a rotation-preventing connection part formed on an end thereof such that the rotation-preventing connection part prevents the fixture or the dental prosthesis from being rotated when the fixture or the dental prosthesis is coupled to the block.

Here, it is preferred that the rotation-preventing connection part have a polygonal, cubic or rounded sectional shape.

The machining is implemented through CAD/CAM, where “CAD” stands for computer-aided design, and “CAM” stands for computer aided machining, and the machining is performed using a CNC milling machine.

The machining is implemented through CAM after a wax mock-up or a resin mock-up is scanned.

The block is formed of a stabilized tetragonal zirconia polycrystalline (TZP)-based material.

The block is formed of a composite of zirconia and alumina.

The block is formed through uniaxial die pressing, cold isostatic pressing or hot isostatic pressing while the bidirectional shrinkage thereof is controlled.

According to another aspect of the present invention, there is provided a dental implant comprising a fixture which is inserted as an artificial dental root at a place where a tooth has been lost, and an artificial tooth which is formed as a block to be secured to the fixture, the block being machined to conform to the shape of a patient's tooth.

According to another aspect of the present invention, there is provided a dental implant comprising a fixture which is inserted as an artificial dental root at a place where a tooth has been lost, an abutment which is secured to the fixture, a screw which secures the abutment to the fixture, and an artificial tooth which is secured to the abutment, wherein the dental implant is formed by machining a block to conform to the shape of a patient's tooth, in which the abutment and the artificial tooth are integrally formed with each other.

The block has a polygonal, cubic or rounded sectional shape at the lower end thereof, to which the fixture or the dental prosthesis is coupled and at which the abutment is formed, to prevent the fixture or the dental prosthesis from being rotated when the fixture or the dental prosthesis is coupled to the block.

According to another aspect of the present invention, there is provided a dental implant comprising a fixture which is inserted as an artificial dental root at a place where a tooth has been lost, an abutment which is secured to the fixture, a screw which secures the abutment to the fixture, and an artificial tooth which is secured to the abutment, wherein the abutment is formed by machining a block formation.

According to another aspect of the present invention, there is provided a method for manufacturing a dental implant, comprising the steps of forming a block using a ceramic material; performing pre-sintering while controlling a shrinkage rate to optimize a machining characteristic of the block; and forming a dental prosthesis by machining the block.

The dental prosthesis comprises an abutment, which is secured to a fixture.

The dental prosthesis comprises an upper artificial tooth structure, which is secured to an abutment.

The dental prosthesis comprises an integration of an abutment and an upper artificial tooth structure, which is secured to the abutment.

The ceramic material is a stabilized tetragonal zirconia polycrystalline (TZP)-based material.

The block is formed of a composite of zirconia and alumina.

The forming step is implemented through uniaxial die pressing, cold isostatic pressing or hot isostatic pressing, to form a block the bidirectional shrinkage of which is controlled.

The block, which is removed after the uniaxial die pressing, undergoes cold isostatic pressing at a pressure over 100 kgf/cm².

The machining is implemented through CAD/CAM, where “CAD” stands for computer-aided design and “CAM” stands for computer aided machining, and the machining is performed using a CNC milling machine.

The machining is implemented through CAM after a wax mock-up or a resin mock-up is scanned.

According to still another aspect of the present invention, there is provided a method for manufacturing a dental implant, comprising the steps of forming a block using a ceramic-based or resin-based material; and forming a dental prosthesis by machining the block.

According to a still further aspect of the present invention, there is provided a method for manufacturing a dental implant, comprising the steps of forming a block using a ceramic material; sintering the block; and forming a dental prosthesis by machining the sintered block.

### ADVANTAGEOUS EFFECTS

Thanks to the features of the block having a structure for joining an abutment and a superstructure for a dental implant and a method for manufacturing the same, advantages are provided in that a dental crown can be easily formed.

### BRIEF DESCRIPTION OF THE DRAWINGS

FIG. 1 is a perspective view illustrating the construction of a block in accordance with an embodiment of the present invention;

FIG. 2 is a perspective view illustrating the construction of a block in accordance with another embodiment of the present invention;

FIG. 3 is a perspective view illustrating the construction of a block in accordance with still another embodiment of the present invention; and

FIG. 4 is a perspective view illustrating the construction of a block in which the rotation-preventing connection part, formed in the block of FIG. 2, is formed in a plural number.

### DESCRIPTION OF REFERENCE NUMERALS FOR MAIN PARTS IN DRAWINGS

100: block
110: rotation-preventing connection part
112: insertion groove

### BEST MODE FOR CARRYING OUT THE INVENTION

Hereafter, preferred embodiments of a block having a structure for joining an abutment and a superstructure for a dental implant and a method for manufacturing the same according to the present invention, constructed as aforementioned above, will be described in detail with reference to the attached drawings.

The present invention relates to a construction and a method wherein a block is formed using a tetragonal zirconia polycrystalline (TZP)-based material having high strength and high toughness, and an abutment or an upper artificial tooth structure secured to the abutment is formed by machining the block.

The abutment or the upper artificial tooth structure secured to the abutment can be formed using the block, or the abutment and the upper artificial tooth structure can be integrally formed with each other using the block.

Here, the upper artificial tooth structure includes a cylinder, an artificial tooth, or the like, and represents all structures related to an artificial tooth that can be installed on the abutment.

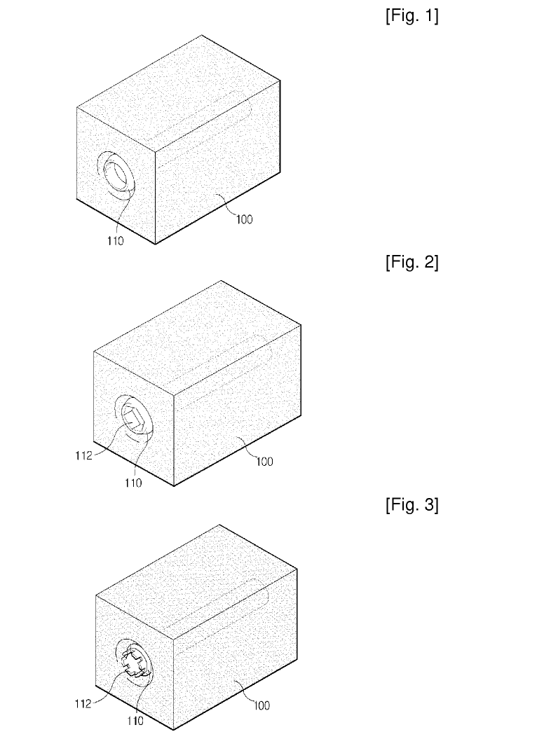

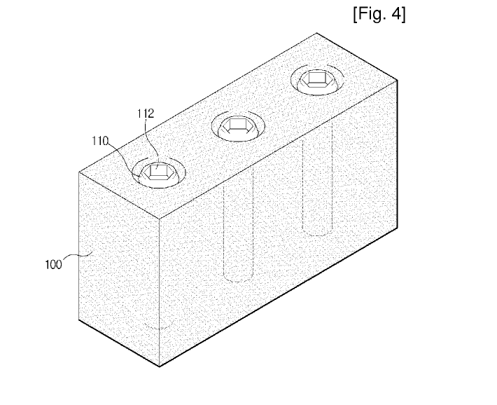

While the block according to the present invention is not specifically limited with respect to the shape and size thereof, the block is formed as a hexahedron so as to be easy to machine. In the case where only an artificial tooth is formed using the block, as shown in FIG. 1, the block is formed such that a rotation-preventing connection part 110 for preventing the rotation of the abutment is exposed to the outside on the lower end of the block 100.

While not shown in the drawings, a fixture has a hexagonal, octagonal or twelve-angled groove defined on the inner surface of the upper end thereof as a rotation-preventing connection part, such that the fixture is prevented from being rotated when the fixture is coupled to the abutment. As shown in FIG. 2, a polygonal section shape, which corresponds to the rotation-preventing connection part, is formed on the inner surface of the lower end of the abutment. Of course, an insertion groove 112 can be additionally defined on the opposite end of the abutment such that a screw for securing the abutment to the fixture can be inserted through the insertion groove 112.

Here, the groove is not limited to a polygonal groove. In order to prevent the fixture and the abutment from being rotated, the groove can have an oval sectional shape, a rounded sectional shape having a non-uniform curvature, or a saw-toothed sectional shape.

Also, a block can be manufactured to include the above-described connection part, as the connection part formed on the lower surface of the cylinder coupled to the abutment. Accordingly, the connection part must not be construed to be limited to a connection part between the abutment and the fixture.

The block 100 is formed of stabilized tetragonal zirconia polycrystalline or a composite of zirconia and oxide. Yttria (Y₂O₃) may be added to the stabilized tetragonal zirconia polycrystalline, and the composite may be granules, such as composite powder, having excellent flowability.

Also, the oxide may be alumina or other ceramic oxides.

A method for manufacturing a block having a structure for joining an abutment and a superstructure for a dental implant in accordance with another embodiment of the present invention comprises the steps of (a) forming a block, the bidirectional shrinkage of which is controlled, through uniaxial die pressing, cold isostatic pressing or hot isostatic pressing, using stabilized tetragonal zirconia polycrystalline or a composite of zirconia and alumina; (b) performing pre-sintering and thereby controlling the shrinkage rate to improve the efficiency with which the formed block is machined; and (c) mechanically machining the consequently formed block.

In the step (a), after implementing uniaxial die pressing, it is preferred that the removed formation be sealed in a rubber mold and be maintained in a vacuum state in order to undergo cold isostatic pressing (CIP). It is preferred that the pressure of the cold isostatic pressing be greater than 100 kgf/cm² to control bidirectional shrinkage in longitudinal and transverse directions. In the step (b), it is preferred that the pre-sintering temperature be set to 800˜1,300° C. and that the block be heated for over 10 hours at a temperature of 200˜400° C. to ensure complete burnout. It is further preferable that the block be held for several hours at a primary sintering point in order to improve the machining efficiency of pre-sintering.

In the step (c), it is preferred that the block be machined using a bur coated with diamond and that the bur be replaced when chipping occurs due abrasion thereof. Also, it is preferred that the hardness (Hv) and the density (g/cm³) of the pre-sintered product suitable for machining be adjusted to a primary sintering condition depending upon the condition of a tool. Hereafter, the method for manufacturing a block for a dental implant in accordance with the present invention, constructed as mentioned above, will be described in further detail with reference to examples.

In the method for manufacturing a block according to the present invention, a powder type ceramic material is used in the following examples, but it is to be noted that other types, different from powder or a resin-based material, can be used.

### Example 1

### A Powder Forming Technique for Bidirectional Shrinkage Control

In the present example, a block is formed in a uniaxial die press having a maximum forming pressure of 20,000 psi and a cold isostatic press having a maximum pressure of 4,000 bar using materials having the compositions given in Table 1 under forming conditions set forth above. In uniaxial die pressing, a mold design for pressing and forming pressure were optimized, and tests for evaluating bidirectional shrinkage upon isostatic pressing were conducted for bidirectional shrinkage control (see Table 2 below).

TABLE 1
The composition of materials of a block adopted for a dental implant

| Classification | Composition |
|---|---|
| Zirconia | 97.0 mol % ZrO2, 3.0 mol % Y₂O₃ |
| Composite of zirconia/alumina | 10~90 vol % ZrO₂, 90~10 vol % Al₂O₃ |

TABLE 2
The condition for forming a block for a dental implant

| | | Holding time | |
|---|---|---|---|
| | | and pressure | Bidirectional |
| Process | Forming pressure | drop | shrinkage control |
| Uniaxial die | Over forming | Over 10 | Pressing |
| Pressing | starting point | Seconds | |
| Cold isostatic | Over 100 Kgf/cm² | Over 10 | Over 1200 Kgf/cm² |
| pressing | | Seconds | Longitudinal and |
| | | | transverse shrinkage |
| | | | control (less than |
| | | | 0.02%) |

In the present example, a technology for controlling bidirectional shrinkage through uniaxial die pressing and cold isostatic pressing was established. In detail, for longitudinal and transverse shrinkage control, the block, primarily formed using a uniaxial die press, was sealed in a rubber mold and was then formed at pressure over 100 kgf/cm² in a cold isostatic press while changing the pressure, so that a difference in bidirectional shrinkage could be realized. Meanwhile, uniaxial die pressing and cold isostatic pressing can be separately or simultaneously adopted depending upon the press system adopted for a block, so that shrinkage rates can be adjusted in longitudinal and transverse directions.

### Example 2

### Techniques for Standardization of the Forming Condition of a Block by Primary Sintering and for the Evaluation of a Shrinkage Rate

In the present example, a technique for standardizing the forming condition of a block through pre-sintering was established. In detail, the blocks having undergone the uniaxial die pressing and the cold isostatic pressing were pre-sintered at various temperatures, and then, by examining the hardness and the density of the blocks, blocks suitable for machining were prepared. Further, by examining the forming shrinkage, attributable to the pressure of cold isostatic pressing (CIP), and pre-sintering shrinkage, a shrinkage evaluation technique was established. In order to improve machining efficiency, the blocks were sintered in a low-temperature sintering furnace while a primary sintering temperature was changed between 990° C. and 1,020° C., and the hardnesses of these pre-sintered products were measured in a micro Vickers hardness tester. Thereupon, after observing the densities according to the Archimedes principle, machining conditions suitable for the adoption of CAD/CAM machining tools were set.

In order to establish the technique for standardization of the forming condition of a block, machining stability must be improved by increasing the resistance to the diamond bur during the machining, and optimum machining conditions must also be established in order to improve machining efficiency in conjunction with the abrasion of the tool, which means that the primarily sintered product must not be too hard or too soft. Accordingly, it is most important to prepare a workpiece suitable for a machining tool by controlling the respective processes (first forming of granular powder—second forming—first sintering).

### Example 3

### Reliability Evaluation of a Block

In order to check the long-term reliability of the method for manufacturing a block having a structure for joining an abutment and a superstructure for a dental implant, after conducting a bidirectional bending strength test, stability was observed through Weibull analysis. First, after preparing thirty Φ16*1.2 T disk pieces made of the same material as a block, the bidirectional bending strength tests were conducted using a universal material tester (Houns-field Test Equipment Ltd., U.K.), and the long-term stability was checked through the Weibull analysis for the measured strength values.

Here, a bidirectional bending strength value over 1,000 MPa, which represents an excellent property value, greater than 6,000 MPa, as the allowable strength value of the abutment for a dental implant, was obtained, and a Weibull coefficient m was 8.41, which means that the long-term stability could be confirmed.

Moreover, in the present invention, in the block having a structure for joining an abutment and a superstructure for a dental implant, it can be envisaged that, before conducting the pre-sintering step, the green formation of the block is formed and then, by sintering the green formation of the block, a final block product can be obtained. That is to say, after forming a molded product as an abutment or an upper artificial structure, by directly sintering the resultant product, a dental prosthesis can be obtained.

In this case, the molded product must be formed to have a size greater than that of the end product, in consideration of shrinkage. When forming the molded product, for example, uniaxial die pressing can be employed, but the forming of the molded product is not limited to such a method.

Furthermore, in the present invention, because the pre-sintering process is an added process, and thus could serve to work against the improvement of productivity in the manufacture of a block suitable for machining, it can be contemplated that, in the course of conducting the pre-sintering and main sintering processes, only the main sintering process can be conducted, and the pre-sintering process can be omitted, in order to obtain a densified block, so that the resultant block can be formed into an upper artificial tooth structure.

In this regard, in the case that the densified block is made of a material having high toughness and high strength, since it is difficult to machine the densified block, a special ceramic cutting tool, such as a diamond, SiC, etc. and a precision machining system suitable for the machining of a difficult-to-cut material must be employed when machining the densified block.

In addition, in order to manufacture an abutment and an upper artificial tooth structure using polymer, in particular, synthetic resin, in place of the abutment and the upper artificial tooth structure made of ceramic, a block made of resin can be formed.

In this case, the sintering process is generally omitted, and the manufacture of the dental prosthesis made of synthetic resin can be considered preferable in view of ease of machining.

As is apparent from the above description, in the present invention, when manufacturing an abutment and a superstructure for a dental implant, entire structures, including the abutment and the superstructure, are not shaped in advance, and instead, a block having a rotation-preventing connection part formed therein is manufactured such that the block can then be machined through CAD/CAM to form the crown of the superstructure. Therefore, the present invention provides a technical concept which can be efficiently applied in conformity with a patient's condition. Therefore, without departing from the basic technical concept of the present invention, various modifications, additions and substitutions are possible for a person having ordinary knowledge in the art.

### INDUSTRIAL APPLICABILITY

As described above, according to the construction of the present invention, by manufacturing a pre-sintered block for an abutment under sintering shrinkage control and by machining the block through CAD/CAM, a method for easily forming a superstructure for an abutment is provided. Due to this fact, when manufacturing, through machining, an implant abutment, an upper artificial tooth structure or an abutment integrated with an upper artificial tooth structure serving as a full ceramic tooth, an excellent manufacturing method having improved productivity, efficiency and workability can be provided.

Also, according to the present invention, in the case that an artificial tooth for a dental implant is formed of ceramic or polymer, a block can be immediately machined to conform to an individual patient without causing any inconvenience due to the necessity to reshape a ready-made abutment having a uniform shape, so that an implantation process can be quickly and conveniently conducted for each patient.

Further, according to the present invention, a block having a rotation-preventing connection part formed on an end thereof to prevent rotation of a fixture is manufactured in advance, and the artificial tooth portion of the block, including the connection part, is machined as the occasion demands, so that shaping according to the measurements of a patient can be more easily conducted compared to the conventional art, in which a wax mock-up or a resin mock-up process is separately conducted for a ready-made product having a uniform shape.

Moreover, according to the present invention, an abutment and a superstructure for a dental implant can be formed of a ceramic material which has high strength and high toughness.

Furthermore, according to the present invention, by forming an abutment and a superstructure for a dental implant using synthetic resin, easy machining of a dental implant is ensured, and selectivity of material for the dental implant can be increased.

In addition, according to the present invention, an abutment and a superstructure for a dental implant can be formed through machining, irrespective of the condition of a sintering process, such as whether it is in a green-formed state, after a pre-sintering or after densification through sintering.

1. A dental implant, in which a fixture is inserted through a portion of a gum at which a tooth has been lost, and is anchored to an alveolar bone as an artificial dental root, and a dental prosthesis is secured to the fixture to form an artificial tooth, wherein a block is formed through machining to serve as an abutment, an upper artificial tooth structure or an integration of an abutment and an artificial tooth structure, and has a rotation-preventing connection part formed on an end thereof such that the rotation-preventing connection part prevents the fixture or the dental prosthesis from being rotated when the fixture or the dental prosthesis is coupled to the block.

2. The dental implant according to claim 1, wherein the rotation-preventing connection part has a polygonal, cubic or rounded sectional shape.

3. The dental implant according to claim 1, wherein the machining is implemented through CAD/CAM, where CAD indicates computer-aided design and CAM indicates computer-aided machining, and the machining is performed using a CNC milling machine.

4. The dental implant according to claim 1, wherein the block is formed of stabilized tetragonal zirconia poly crystalline (TZP).

5. The dental implant according to claim 1, wherein the block is formed of a composite of zirconia and alumina.

6. The dental implant according to claim 4, wherein the stabilized tetragonal zirconia polycrystalline or the composite of zirconia and alumina is formed through uniaxial die pressing, cold isostatic pressing or hot isostatic pressing.

7. The dental implant according to claim 1, wherein the block is formed of a resin-based material.

8. The dental implant according to claim 1, wherein the machining is implemented through CAM after a wax mock-up or a resin mock-up is scanned.

9. A method for manufacturing a dental implant, comprising the steps of: forming a block; performing pre-sintering while controlling a shrinkage rate, to optimize machining characteristics of the block; and forming a dental prosthesis by machining the block.

10. The method according to claim 9, wherein the dental prosthesis comprises an abutment which is secured to a fixture.

11. The method according to claim 9, wherein the dental prosthesis comprises an upper artificial tooth structure which is secured to an abutment.

12. The method according to claim 9, wherein the dental prosthesis comprises an integrated structure comprising an abutment and an upper artificial tooth structure, which is secured to the abutment.

13. The method according to claim 9, wherein the block is formed of stabilized tetragonal zirconia poly crystalline (TZP).

14. The method according to claim 9, wherein the block is formed of a composite of zirconia and alumina.

15. The method according to claim 9, wherein the forming step is implemented through uniaxial die pressing, cold isostatic pressing or hot isostatic pressing, to form a block bidirectional shrinkage of which is controlled.

16. The method according to claim 15, wherein the block, which is removed after the uniaxial die pressing, undergoes cold isostatic pressing at a pressure over 100 kgf/cm.

17. The method according to claim 9, wherein the machining is implemented through CAD/CAM, where CAD indicates computer-aided design and CAM indicates computer aided machining, and the machining is performed using a CNC milling machine.

18. The method according to claim 9, wherein the machining is implemented through CAM after a wax mock-up or a resin mock-up is scanned.

19. A method for manufacturing a dental implant, comprising the steps of: forming a block; and forming a dental prosthesis by machining the block.

20. A method for manufacturing a dental implant, comprising the steps of: forming a block; main-sintering the block; and forming a dental prosthesis by machining the main-sintered block.

21. The dental implant according to claim 5, wherein the stabilized tetragonal zirconia polycrystalline or the composite of zirconia and alumina is formed through uniaxial die pressing, cold isostatic pressing or hot isostatic pressing.
